(19) United States
(12) Patent Application Publication
(10) Pub. No.: US 2010/0092346 A1
(43) Pub. Date: Apr. 15, 2010

(54) PHOTOCATALYST DEVICE USING POROUS PIPE AND AIR PURIFICATION APPARATUS USING THE SAME

(76) Inventor: DONG HYUN JEON, Seongnam-si (KR)

Correspondence Address: HOLME ROBERTS & OWEN LLP, 1700 LINCOLN STREET, SUITE 4100, DENVER, CO, 80203, US

(21) Appl. No.: 12/576,353

(22) Filed: Oct. 9, 2009

(30) Foreign Application Priority Data
Oct. 9, 2008 (KR) 10-2008-0099200

(51) Int. Cl. B01J 19/08

(52) U.S. Cl. 422/122; 422/186.3

(57) ABSTRACT

The present invention relates to an air purification apparatus designed to sterilize contaminated air, eliminate bad smells and decompose harmful substances, and more particularly, to a photocatalyst device using a porous pipe, which can improve photocatalyst reactions with ultraviolet light, and an air purification apparatus using the photocatalyst device. The photocatalyst device of the present invention comprises a porous pipe having a plurality of holes bored therethrough, the porous pipe being capable of receiving an ultraviolet lamp therein; and a photocatalyst pouch consisting of a glass fiber coated with a photocatalyst, the photocatalyst pouch configured to surround the porous pipe.

### BACKGROUND OF THE INVENTION

1. Field of the Invention

The present invention relates to an air purification apparatus designed to sterilize contaminated air, eliminate bad smells and decompose harmful substances, and more particularly, to a photocatalyst device using a porous pipe, which can improve photocatalyst reactions with ultraviolet light, and an air purification apparatus using the photocatalyst device.

2. Description of the Related Art

Generally, an air purification apparatus is used for sterilizing and deodorizing contaminated air in a room and decomposing harmful substances so as to furnish clean air. The air purification apparatus generates ions to sterilize and deodorize air and decompose harmful substances included in the air. The generated ions are coupled with moisture or oxygen in the air to generate OH radicals, and the generated OH radicals are coupled with various organic or inorganic reactants to stabilize contamination sources. Currently, air purification apparatuses are coupled to various kinds of devices such as an air sterilizing device or a cold/warm air blower.

Such an air purification apparatus includes a case body having an air suction hole and an air discharge hole, a power source, an air pan rotated by power supplied from the power source to suck in air through the air suction hole and discharge air through the air discharge hole, and a photocatalyst device for emitting ultraviolet light generated by power received from the power source, which creates ions through photo-oxidization and photo-reduction reactions between the emitted ultraviolet light and the photocatalyst.

FIG. 1 shows a general photocatalyst device.

Referring to FIG. 1, a conventional photocatalyst device 10 includes an ultraviolet lamp 1, a glass tube 2 for receiving the ultraviolet lamp 1 therein, and a photocatalyst pouch 3 having a pouch shape configured to surround the glass tube 2 and coated with a TiO₂ photocatalyst to cause photo-oxidization and photo-reduction reactions between the photocatalyst and the ultraviolet light emitted from the ultraviolet lamp 1 so that anions are emitted.

The photocatalyst pouch 3 includes a fiber carrier made of a class of polyamide, such as Kevlar, Twaron, Glodflex and Stabond, or a polyethylene series, such as Dyneema, Spectra, Famostone and Aristone, and a photocatalyst film adhering to the fiber carrier.

The ultraviolet lamp 1, the glass tube 2 and the photocatalyst pouch 3 are coupled by a fixing means 4. The fixing means may be made of a gel, such as silica gel, glass or cement, which may endure ultraviolet light.

The photocatalyst device 10 so configured emits ultraviolet light when power is supplied to the ultraviolet lamp 1, and the emitted ultraviolet light passes through the glass tube 2 and causes photo-oxidization and photo-reduction reactions with the photocatalyst formed on the photocatalyst pouch 3, thereby generating ions to remove contaminants in the air.

As mentioned above, the ultraviolet lamp of a conventional photocatalyst device is formed integrally with the glass tube and the photocatalyst pouch by means of the fixing means. Therefore, if the ultraviolet lamp fails, the entire device including the photocatalyst pouch, the glass tube and the ultraviolet lamp must be replaced even though the photocatalyst pouch is still useable, which is expensive. Also, since useable photocatalyst pouches are unnecessarily discarded, the number of discarded special fiber pouches increases, which may cause environmental contamination.

In addition, a conventional photocatalyst device comprises the glass tube for mounting the photocatalyst pouch, and the glass tube may be broken when the air purification apparatus is impacted or the photocatalyst device is exchanged. Also, the photocatalyst pouch of a conventional photocatalyst device has an air passage, however the inside of the passage is closed due to the glass tube, so ventilation is not achieved. Thus, there is a problem in that the sterilizing, deodorizing and harmful substance decomposing effects are deteriorated.

In a case where the air purification apparatus is employed in a cool/warm air blower or an air sterilizing device, the photocatalyst device comes into direct contact with cold air from a heat exchanger in the cold/warm air blower, so condensation occurs in the glass tube due to a difference in temperature between the hot ultraviolet lamp and the cold air, thereby shortening the life span of the photocatalyst pouch.

### SUMMARY OF THE INVENTION

An object of the present invention is to provide a photocatalyst device using a porous pipe, which may improve photocatalyst reactions so as to enhance the ability to sterilize and deodorize air and decompose harmful substances with ultraviolet light, and also ensure easy attachment or detachment of an ultraviolet lamp; and an air purification apparatus using the photocatalyst device.

According to an aspect of the present invention for achieving the objects, there is provided a photocatalyst device, which includes a porous pipe having a plurality of holes bored therethrough, the porous pipe being capable of receiving an ultraviolet lamp therein; and a photocatalyst pouch consisting of a glass fiber coated with a photocatalyst, the photocatalyst pouch configured to surround the porous pipe.

The photocatalyst device may further include a reflective mirror surrounding at least a part of the outer side of the porous pipe surrounded by the photocatalyst pouch, the reflective mirror having a reflective surface for reflecting ultraviolet light, which passes through the holes of the porous pipe and the photocatalyst pouch and exits therefrom, onto the outside of the photocatalyst pouch.

The photocatalyst device may further include an ultraviolet lamp fixing means for detachably fixing the ultraviolet lamp.

The ultraviolet lamp fixing means may function as an electrical connection means.

The reflective mirror may have a cross section in the shape of a circular arc.

The photocatalyst is preferably TiO₂.

The porous pipe is preferably made of aluminum.

The porous pipe may be further coated with a photocatalyst.

According to another aspect of the present invention, there is provided an air purification apparatus, which includes a case body having an air suction hole and an air discharge hole therein; at least one air fan for allowing air sucked through the air suction hole to circulate and discharging the air through the air discharge hole; and a photocatalyst device including a porous pipe having a plurality of holes bored therethrough, the porous pipe being capable of receiving an ultraviolet lamp therein, a photocatalyst pouch consisting of a glass fiber coated with a photocatalyst, the photocatalyst pouch configured to surround the porous pipe, and a reflective mirror surrounding at least a part of the outer side of the porous pipe surrounded by the photocatalyst pouch, the reflective mirror having a reflective surface for reflecting ultraviolet light, which passes through the holes of the porous pipe and the photocatalyst pouch and exits therefrom, onto the outside of the photocatalyst pouch, wherein the reflective surface of the reflective mirror is arranged in a direction opposite to an air circulating direction.

### BRIEF DESCRIPTION OF THE DRAWINGS

FIG. 1 is a view showing a general photocatalyst device;

FIG. 2 is a view showing a photocatalyst device according to a first embodiment of the present invention;

FIG. 3 is a side view of the photocatalyst device of FIG. 2;

FIG. 4 is a sectional view of the photocatalyst device of FIG. 2;

FIG. 5 is a view showing a photocatalyst device according to a second embodiment of the present invention;

FIG. 6a is a view showing the photocatalyst device according to the second embodiment of the present invention employed in a cold/warm air blower; and

FIG. 6b is a view showing the photocatalyst device according to the second embodiment of the present invention employed in an air purification apparatus.

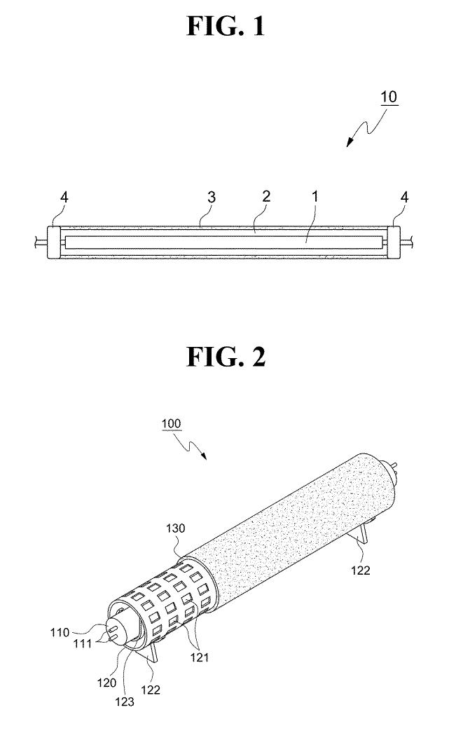

### DESCRIPTION OF THE PREFERRED EMBODIMENT

Hereinafter, the configuration and operation of a photocatalyst device according to the present invention will be described in detail with reference to the accompanying drawings.

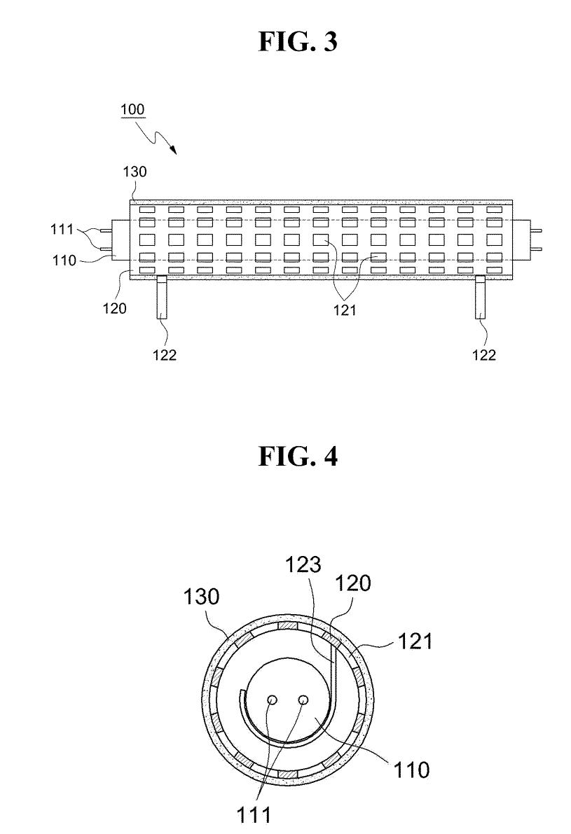

FIG. 2 is a perspective view showing a photocatalyst device according to the present invention, FIG. 3 is a side view showing the photocatalyst device according to the present invention, and FIG. 4 is a sectional view showing the photocatalyst device.

Referring to FIGS. 2 to 4, a photocatalyst device 100 according to the present invention includes a porous pipe 120 and a photocatalyst pouch 130.

The porous pipe 120 is formed in the shape of a pipe, which has a diameter so that an ultraviolet lamp 110 is easily inserted thereinto and removed therefrom and surrounds the ultraviolet lamp 110, and a plurality of ultraviolet light emission holes 121 are formed in the outer peripheral surface of the porous pipe. In addition, the porous pipe 120 may be cast of aluminum (Al), titanium (Ti) or steel (F₂), among which aluminum is preferred due to its inexpensiveness. The plurality of ultraviolet light emission holes 121 formed in the porous pipe 120 allow ultraviolet light emitted from the ultraviolet lamp 110 to pass out of the porous pipe 120 when the ultraviolet lamp 110 operates and also for facilitating air ventilation. Inner or outer sides of the porous pipe may be coated with a photocatalyst such as titanium dioxide. The ultraviolet lamp used in the present invention may be a straight fluorescent lamp having an ultraviolet light wavelength range of 360˜365 nm. Alternatively, an LED lamp whose wavelength is controlled to 315˜400 mm may also be used. The porous pipe preferably has a circular cylindrical shape but may have other cylindrical shapes having modified cross sections, such as triangular, rectangular, hexagonal and octagonal cylindrical shapes.

The photocatalyst pouch 130 is configured in the form of a cylindrical pouch to surround the outer side of the porous pipe 120 and includes a fiber pouch having elasticity so as to be in close contact with the porous pipe 120 and a photocatalyst film stuck to the fiber pouch to produce photo-oxidization and photo-reduction reactions with the ultraviolet light. The photocatalyst film is formed by coating the fiber pouch with titanium dioxide (TiO₂) photocatalyst by sol-dipping and sintering.

The ultraviolet lamp 110 should be fixed such that it does not move when operating, but can be easily inserted into and removed from the porous pipe 120. The ultraviolet lamp 110 may be fixed in such a manner that lamp pins 111 of the ultraviolet lamp 110 may be inserted into a lamp socket (not shown) formed in a case body of an air purification apparatus. Alternatively, the ultraviolet lamp may be fixed by an electrical connection means having a lamp socket on its one surface and a cable on the other surface for connection with the lamp socket and a power source, wherein the electrical connection means may cover both sides of the porous pipe 120 such that the surface having the lamp socket is inserted into the porous pipe 120. As another alternative, as shown in FIG. 2, the ultraviolet lamp 110 may be fixed by fixing hooks 123 having elasticity which are respectively provided at both inner ends of the porous pipe 120. The power connection means is configured to ensure easy attachment or detachment. The power connection means may be detachably attached to the porous pipe 120 by means of screws or hooks.

In the photocatalyst device 100 so configured, the ultraviolet lamp 110 emits ultraviolet light when supplied with power. The emitted ultraviolet light causes photo-oxidization and photo-reduction reactions with the photocatalyst coated on the photocatalyst pouch 130 (←120), thereby generating ions. In a case where the porous pipe is coated with the photocatalyst, ions are also generated on the surface of the porous pipe 120 due to photo reactions.

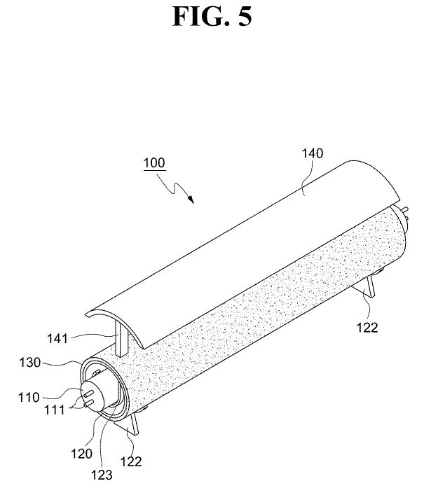

FIG. 5 shows a photocatalyst device according to a second embodiment of the present invention, which further includes a reflective mirror 140 in comparison to the photocatalyst device of the first embodiment.

The reflective mirror 140 may be formed to have a length corresponding to the porous pipe 120, but somewhat longer or shorter than the porous pipe 120. Preferably, the reflective mirror 140 is formed so as to be longer than the porous pipe 120. Also, the reflective mirror 140 has a shape configured to surround at least a part of the outer side of the porous pipe 120. The reflective mirror 140 preferably has a cross section in the shape of a circular arc, but may have various shapes concave toward the porous pipe 120. A reflective surface is formed on the concave portion of the reflective mirror 140 to reflect the incident ultraviolet light. The reflective mirror 140 has connection bars 141 at both inner sides that face the porous pipe 120 and is connected to the porous pipe 120 by the connection bars 141. The photocatalyst pouch 130 has a groove formed at a location corresponding to the porous pipe 120 at which the connection bars 141 are connected.

The reflective mirror 140 reflects ultraviolet light that has passed through the holes 121 of the porous pipe 120 and the photocatalyst pouch 130, back onto the outside of the photocatalyst pouch 130. The reflected ultraviolet light generates ions by photo-oxidization and photo-reduction reactions with the photocatalyst coated on the outer side of the photocatalyst pouch 130, and also the ultraviolet light that has passed through the photocatalyst pouch 130 generates ions by photo-oxidization and photo-reduction reactions with the photocatalyst coated on the outer side of the porous pipe 120.

Also, the porous pipe 120 includes a fixing means 122 at an outer center or at each of both outer ends thereof for coupling with the case body. The fixing means 122 may be a screwing means or a sliding coupling means, which ensures easy attachment and detachment. Thus, a fixing means (not shown) corresponding to the fixing means 122 should be formed inside the case body.

The aforementioned photocatalyst device 100 may be installed alone, or employed in a cold/warm air blower or an air purification apparatus.

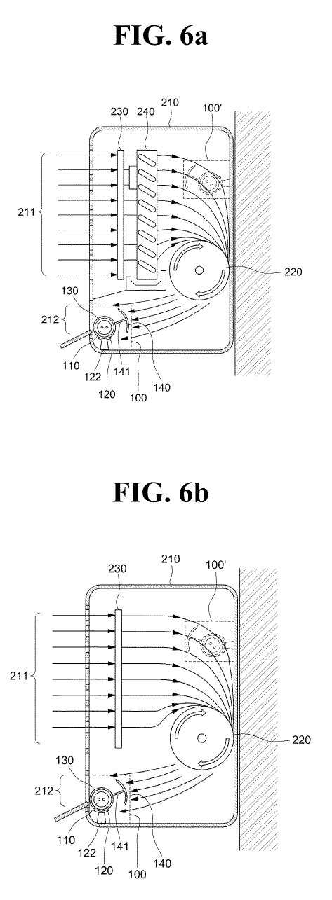

FIG. 6a shows the photocatalyst device according to the second embodiment of the present invention employed in a cold/warm air blower, and FIG. 6b shows the photocatalyst device according to the second embodiment of the present invention employed in an air purification apparatus.

As shown in FIGS. 6a and 6b, the air purification apparatus and the cold/warm air blower may be distinguished depending on the presence of a heat exchanger 240. Thus, the following description will be focused on FIG. 6a.

Specifically, a cold/warm air blower 200 having air sterilizing, deodorizing and harmful substance decomposing functions includes a case body 210, an air fan 220, an air filter 230, a heat exchanger 240 and a photocatalyst device 100 that are fixedly provided in the case body 210.

The case body 210 is formed with an air suction hole 211 for allowing air to be sucked into the case body and an air discharge hole 212 for discharging the air which has been subjected to heat exchange, sterilization, deodorization and harmful substance decomposition. The air suction hole 211 and the air discharge hole 212 (←12) may be configured such that they face the front, or in other various ways, for example, to respectively face front-upper and front-lower sides, or right and left sides. Also, the case body may be formed with a screwing means for fixing the photocatalyst device 100 therein, for example a boss or a slide. In addition, the case body 210 includes a power source (not shown) including a lamp socket to which the lamp pin 111 of the ultraviolet lamp 110 is connected.

The air fan 220 is suitably arranged according to the configuration of the air suction hole 211 and the air discharge hole 212, thereby sucking air in through the air suction hole 211, causing the sucked air to circulate, and then discharging the air through the air discharge hole 212.

The air filter 230 primarily filters off relatively larger contaminants from the air sucked in by the air fan 220. Though only one air filter 230 is illustrated in FIGS. 6a and 6b (←FIGS. 4a and 4b), a plurality of air filters 230 may be installed.

The heat exchanger 240 includes a cooler (not shown) for decreasing air temperature using a coolant and a heater (not shown) for increasing air temperature using a heating wire, thereby increasing or decreasing the temperature of the air that has passed through the air filter 30.

The photocatalyst device 100 is threadly engaged or sliding-coupled to the coupling means of the case body 210 by the fixing means 122 formed at the porous pipe 120. The photocatalyst device 100 generates ions by photo-oxidization and photo-reduction reactions between the ultraviolet light and the photocatalyst, thereby sterilizing and deodorizing the air that passes through the heat exchanger 240 and also decomposing harmful substances included in the air. The reflective mirror 140 (←110) of the photocatalyst device 100 is arranged to have its reflective surface in a direction opposite to the air circulating direction such that the air advancing to the air discharge hole 212 by the heat exchanger 240 does not directly collide with the porous pipe 120 and the ultraviolet lamp 110 of the photocatalyst device 100.

In addition, the photocatalyst device 100 may be located near the air discharge hole 212 of the case body 210 as shown in FIGS. 6a and 6b or at a side facing the air suction hole 211. Substantially, one or more photocatalyst devices may be installed at any place where air circulates.

As discussed above, according to the present invention, when the life span of the ultraviolet lamp of the photocatalyst device expires, it is possible to replace only the ultraviolet lamp with a new one. Thus, there is an advantage in that users can reduce the cost required for replacement and also unnecessary environmental contamination can be prevented.

Further, the photocatalyst device of the present invention further includes the reflective mirror, so that ultraviolet light reflected from a reflective surface of the reflective mirror causes secondary photo-oxidization and photo-reduction reactions with the photocatalyst coated on the outer sides of the photocatalyst pouch and the photocatalyst pipe, thereby generating a larger amount of ions. In other words, the photocatalyst device of the present invention has an advantage of further improving sterilizing, deodorizing and harmful substance decomposing effects.

In addition, in a case where the photocatalyst device of the present invention with the reflective mirror further provided is employed in a cold/warm air blower, the reflective surface of the reflective mirror is disposed in a direction opposite to the air circulating direction, so that the reflective mirror prevents the cold air supplied by a heat exchanger from coming into direct contact with the photocatalyst pouch and the photocatalyst pipe, thereby preventing condensation on the photocatalyst device. Moreover, there is an effect in that the life span can be prevented from being shortened by deformation or separation of the photocatalyst pouch and the photocatalyst film of the porous pipe due to air.

It will be easily understood by those skilled in the art that the present invention is not limited to the aforementioned typical preferred embodiments but various modifications, changes and alternations can be made thereto without departing from the spirit of the invention defined. If the modifications, changes and alternations will be considered to fall in the scope of the present invention defined by the appended claims, the technical spirit thereof should also be considered to fall in the scope of the present invention.

What is claimed is:

1. A photocatalyst device, comprising:
a porous pipe having a plurality of holes bored therethrough, the porous pipe being capable of receiving an ultraviolet lamp therein; and
a photocatalyst pouch consisting of a glass fiber coated with a photocatalyst, the photocatalyst pouch configured to surround the porous pipe.

2. The photocatalyst device as claimed in claim 1, further comprising a reflective mirror surrounding at least a part of an outer side of the porous pipe surrounded by the photocatalyst pouch, the reflective mirror having a reflective surface for reflecting ultraviolet light, which passes through the holes of the porous pipe and the photocatalyst pouch and exits therefrom, onto the outside of the photocatalyst pouch.

3. The photocatalyst device as claimed in claim 1, further comprising an ultraviolet lamp fixing means for detachably fixing the ultraviolet lamp.

4. The photocatalyst device as claimed in claims 1, wherein the ultraviolet lamp fixing means functions as an electrical connection means.

5. The photocatalyst device as claimed in claim 2, wherein the reflective mirror has a cross section in a shape of a circular arc.

6. The photocatalyst device as claimed in claim 1, wherein the photocatalyst is TiO₂.

7. The photocatalyst device as claimed in claim 1, wherein the porous pipe is made of aluminum.

8. The photocatalyst device as claimed in claim 1, wherein the porous pipe is further coated with a photocatalyst.

9. An air purification apparatus, comprising:
a case body having an air suction hole and an air discharge hole therein;
at least one air fan for allowing air sucked through the air suction hole to circulate and discharging the air through the air discharge hole; and
a photocatalyst device including a porous pipe having a plurality of holes bored therethrough, the porous pipe being capable of receiving an ultraviolet lamp therein, a photocatalyst pouch consisting of a glass fiber coated with a photocatalyst, the photocatalyst pouch configured to surround the porous pipe, and a reflective mirror surrounding at least a part of an outer side of the porous pipe surrounded by the photocatalyst pouch, the reflective mirror having a reflective surface for reflecting ultraviolet light, which passes through the holes of the porous pipe and the photocatalyst pouch and exits therefrom, onto the outside of the photocatalyst pouch,
wherein the reflective surface of the reflective mirror is arranged in a direction opposite to an air circulating direction.

10. The photocatalyst device as claimed in claim 2, further comprising an ultraviolet lamp fixing means for detachably fixing the ultraviolet lamp.

11. The photocatalyst device as claimed in claim 2, wherein the ultraviolet lamp fixing means functions as an electrical connection means.
